(19) United States
(12) Patent Application Publication
(10) Pub. No.: US 2007/0087875 A1
(43) Pub. Date: Apr. 19, 2007

(54) Roller chain automatic transmission

(75) Inventor: Lloyd E. Weaver, Harpswell, ME (US)

Correspondence Address: PATRICK R. SCANLON;PRETI FLAHERTY BELIVEAU & PACHIOS LLP, ONE CITY CENTER, PORTLAND, ME, 04112-9546, US

(73) Assignee: LEW HOLDINGS, LLC

(21) Appl. No.: 11/580,430

(22) Filed: Oct. 13, 2006

Related U.S. Application Data
(60) Provisional application No. 60/726,274, filed on Oct. 13, 2005.

(51) Int. Cl. F16H 55/54; F16H 63/00

(52) U.S. Cl. 474/51; 474/156; 474/49

(57) ABSTRACT

An automatic transmission comprised of toothed sprocket segments to form varying dual sprocket diameters with parallel shafts to achieve a wide range of ratios using scissor-type linkages to vary the sprocket diameters actuated by coordinated hydraulic cylinders in each sprocket assembly which are in turn actuated by a single double acting master cylinder to coordinate final sprocket diameters such that a constant length chain can be used at any selected ratio position on the master cylinder.

### CROSS REFERENCES TO RELATED APPLICATIONS

This application claims the benefit of U.S. Provisional Application Ser. No. 60/726,274, filed Oct. 13, 2005.

### BACKGROUND OF THE INVENTION

The current energy crisis demands more efficient automatic transmission solutions for vehicles that are flexible, low cost and long lived. In vehicle transmissions in particular, we have been plagued with geared automatic transmission technology that has changed little in 50 years. Such transmissions are heavy and getting heavier and less efficient by adding more ratios or getting less rugged and less efficient than manual transmissions by use of steel belts and pulleys in CVTs (continuously variable transmissions). Efficiency is so poor, present automatic transmissions require oil coolers to stay operational. Indeed, such transmissions do well to average 80-85 percent efficiency (lowest heavily loaded). Manual automobile transmissions average about 90% efficiency.

One proposed transmission is the new steel-belted automobile CVT whereby one pulley diameter gets bigger and one smaller etc. Thus, if a pulley size ratio is 2:1, this creates an overall ratio of 4 (2 squared) because both pulleys can change the full amount. This is the big appeal to such designs, it allows for a very large ratio (in say a 3:1 dual sprocket arrangement, the overall ratio is 9:1, a heavy truck ratio) in a very compact space, and it's a simple arrangement. High ratios are needed to improve fuel efficiency in cars and with big trucks moving heavy loads up mountain roads. But, CVTs use “friction force” to transfer torque and have limited ratio capability, about 6:1. This is a big disadvantage for two main reasons; CVTs can be easily “smoked” (ruined) by slippage when heavily loaded, and developing belts for different transmission sizes is a monumental task. Given its belt slipping ability, no one should pull a trailer up a mountain road using a CVT transmission.

### SUMMARY OF THE INVENTION

The present invention breaks this impasse in automatic transmissions by exceeding the best manual transmission today in efficiency. It can approach this efficiency using a single set of varying diameter roller chain sprockets because it is in effect a single set of roller chain sprockets which are known to average 98.5% efficiency in normal use. A roller chain is efficient because it is essentially a wheel and axle means to transfer rotational loads to different RPMs.

This present invention uses the principle of dual pulleys also, but changes sprocket diameters instead, hence no slippage problems. Simple hydraulic cylinders change the position of a scissor-jack-type linkage to move sprocket segments up and down in unison to change RPM ratios.

In doing the rotational centrifugal force calculations on the sprocket sectors (tendency to fly out), it's found very little force is needed on scissor jack links to change sprocket sizes. Indeed, the sprocket sectors would need to be “held in” under most circumstances (high RPMs). The “scissor-jack” principle is thus suitable. Also, such a transmission can be shifted when stopped. The drawings display eight sprocket segments as the chain motion is much smother.

One will see that when shifting one sprocket is expanding and the other reducing (or reverse), the chain will ride up and over some sprocket teeth since the pitch will not be in sync during shifting. This is not a problem. The side plate guides this process so the chain can't jump off track, and the transmission controller will momentarily clutch-out or eliminate the torque when shifting. This can be done very fast, in a fraction of a second or a few revolutions of the sprockets (or with no rotation). It's very similar when a bicycle derailleur changes rear sprocket positions, but is much simpler and smoother in operation. Plus, sprocket and chain are well lubed and of very high hardness. Thus, it can change effortlessly into new sprocket “pitch” that perfectly “fits” the new high tension chain side number of teeth being used. In other words, unlike CVT belt transmissions, a roller chain unit is like a gear transmission (but much more efficient than gears), i.e. there are unique slot positions that fit the chain pitch in each ratio just like separate gear sets are engaged. Once the sprocket segment radial positions are calibrated on the shifting cylinder, it's ready to operate. Manual or automatic shifting using the exact same design is possible. Also, hydraulics don't have to be used to shift sprocket sectors to larger or smaller diameters using scissor mechanisms, small servo driven cylinders can also be used.

One feature of this transmission, as compared to belted CVTs, is one can't “smoke” this chain transmission and thus ruin it. And unlike a big development and cost effort to develop and test a new “steel belt” for a CVT, a computer can be programmed to design new chain transmissions around different chain sizes in a few seconds for whatever ratio range, torque or speed combination is needed, and when done, it will work.

Some advantages of this invention over steel belted CVTs or geared automatic transmissions are: lower costs, larger design flexibility and broad range of sizes possible with fast computer design using standard chain types, greater toughness, and far greater efficiency.

### DESCRIPTION OF THE DRAWINGS

FIG. 1 is a side section view of one embodiment of a roller chain transmission.

FIG. 2 is a cross-sectional view of the roller chain transmission taken along line A-A′ of FIG. 1.

### DETAILED DESCRIPTION OF THE INVENTION

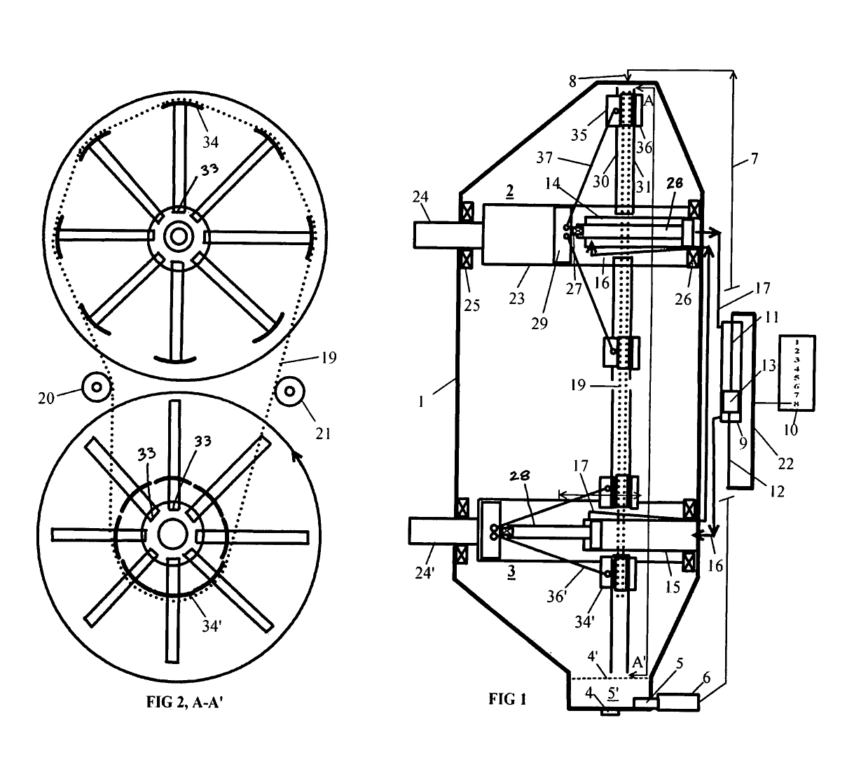

Starting with FIG. 1, a roller chain transmission in accordance with one embodiment has an outer housing 1 housing a segmented variable diameter top sprocket assembly 2 and similar lower sprocket assembly 3. The roller chain transmission further includes a recirculating lubrication system comprising a drain plug 4, lubricating oil 4′, and a circulating pump 5 with filter 6. Lubricating oil 4′ is circulated through lines 7 and empties onto the top sprocket assembly 2 at an inlet 8 wherein oil 4′ and trickles back down to sump 5′.

Shifting master cylinder 9 is shown with shifting positions 10 and has rods 11 and 12 on either end of piston 13 to cause hydraulic fluid such as oil to shift into and out of sprocket shifting sprocket cylinders 14 and 15 respectively. As can be seen, movement of the piston 13 in master cylinder 9 causes oil flows 16 and 17 into and out of cylinders 14 and 15, respectively, causing one cylinder to contract and one to extend simultaneously. Thus, one sprocket is always getting larger while the other is getting smaller when shifting, making the chain 18 length needed constant. This is similar to existing metal belted CVT or usual rubber belt snowmobile transmissions, which are common. Chain 19 is kept tight with spring-loaded sprockets 20 and 21 of FIG. 2 (their details not shown). As shown, the shifting cylinder 9 is manually positioned into the detent position corresponding to a selected one of the eight shifting positions of (detailed detent design not shown). But the position of rods 11 and 12 as positioned by yoke 22 could be easily automated, hence the designation of this invention as an automatic transmission.

Sprocket assemblies 2 and 3 are substantially identical, so from hereon, only one will generally be described. Each has a hub 23 with an input or output shaft 24/24′ rotatively mounted to the housing 1 via bearings 25 and 26 on either end thereof. As can be seen, cylinders 14 and 15 are attached to the right-hand position of housing 1 and extend into hubs 23. However, they could be alternated with say the input shaft 24 pointing left as shown, and the output shaft 24′ pointing right (now shown left). Since hydraulic fluid is moving the cylinders 14 and 15 in and out, it makes no difference which direction these shafts point as long as they are parallel to each other and chain 19 aligns. Each cylinder 14 and 15 has a cylinder rod 28 with an end bearing 27 which is also attached to a rod guide 29 that slides inside hub 23 as the rod 28 moves in and out. Each hub 23 has inner and outer sprocket slotted disks 30 and 31 with lower stops 33 (see FIG. 2) on each slot to stop sprocket segments 34 (shown 34′ on the lower assembly 3) from descending too far. All sprocket segments 34 are of the same shape and have tabs 35 and 36 that slide in the slots of 30 and 31 respectively. Links 37 are riveted at one end to tab 35 and at the other end to rod guide 29 (not shown in detail). Thus, as shown, as the cylinder rods 28 expand and contract, the links 37 cause the sprocket segments 34 to move in and out radially in a coordinated way to keep the chain length constant. The minimum position of sprocket segments 34 are such that the angle of link 36′, as an example, is about 19 degrees. Thus, ten pounds force on the link 36′ is 3.2 pounds of radial force to move segments 34 (sin 19 degrees times ten pounds). It's clear from scissor lift design that a smaller angle than 19 degrees is practical. Thus this link 36′ arrangement as shown is not the minimum possible angle, making a smaller minimum sprocket diameter 34′ possible (see FIG. 2).

Hydraulic cylinders are not the only way to move segments in and out in unison, although it is quite foolproof method in achieving coordinated in and out movements, electric driven screw cylinders can also accomplish this task. Or radial screws emanating up from the hubs 23 (not shown) with means to turn a carrying nut to shift cantilevered segments 34 off these screws could also be used to vary sprocket diameters. Indeed, any number of ways could be devised to move the sprocket segments in and out in a coordinated manner and form a part of this invention. Note also the chain 19 is kept from jumping off by close proximity of segment sides to the insides of slotted side disks 30 and 31. Torque is transmitted through the chain to 2 and 3 via tabs 35 and 35 in the slots of 30 and 31 whereby 31 and 32 are welded to hubs 23 respectively.

Since the chain pitch will not be in sync with the sprocket pitches when shifting, i.e. when one sprocket is radial expanding and the other reducing (or reverse), the chain 19 will ride up and over some sprocket teeth during the 2-3 revolutions required to shift. Thus, a slightly longer chain is needed at this moment which is accommodated by stored chain length of tightening sprockets 20 and 21 (shown 20), depending if in forward or reverse. The side plates 30/31 guide shifting so the chain can't jump off track, and the automatic transmission controller (not shown) will momentarily clutch-out (input clutch not shown) to eliminate the torque when shifting to make shifting even easier. This is manually clutched if shifting manually. This can be done very fast, in a fraction of a second or a few revolutions of the sprockets (or with no rotation if the vehicle is at a standstill and there is no sprocket rotation).

Clearly, this transmission invention is suitable for a broad range of applications such as heavy duty trucks and mining vehicles, army tanks, ordinary trucks and cars, and even bicycles.

While specific embodiments of the present invention have been described, it should be noted that various modifications thereto can be made without departing from the spirit and scope of the invention as defined in the appended claims.

What is claimed is:

1. A roller chain transmission comprising:
a first sprocket assembly comprising a first plurality of sprocket segments arranged circumferentially about an axis and means for radially moving said first plurality of sprocket segments in a coordinated manner;
a second sprocket assembly comprising a second plurality of sprocket segments arranged circumferentially about an axis and means for radially moving said second plurality of sprocket segments in a coordinated manner; and
a chain connected between said first and second sprocket assemblies.

2. The roller chain transmission of claim 1 wherein said first sprocket assembly further includes at least one disk having a plurality of first slots in which said first plurality of sprocket segments are slidingly mounted in said first slots, and wherein said second sprocket assembly further includes at least one disk having a plurality of second slots in which said second plurality of sprocket segments are slidingly mounted in said second slots.

3. The roller chain transmission of claim 1 wherein said means for radially moving said first plurality of sprocket segments includes a first scissor-jack-type linkage and means for actuating said first scissor-jack-type linkage, and wherein said means for radially moving said second plurality of sprocket segments includes a second scissor-jack-type linkage and means for actuating said second scissor-jack-type linkage.

4. The roller chain transmission of claim 3 wherein said means for actuating said first scissor-jack-type linkage includes a first hydraulic cylinder, and wherein said means for actuating said second scissor-jack-type linkage includes a second hydraulic cylinder.
